(19) United States
(12) Patent Application Publication
(10) Pub. No.: US 2026/0323566 A1
(43) Pub. Date: Oct. 15, 2026

(54) POSITIONING METHOD AND TERMINAL

(71) Applicant: Lenovo (Beijing) Limited, Beijing (CN)

(72) Inventors: Jianfeng WANG, Beijing (CN); Haiming WANG, Beijing (CN)

(21) Appl. No.: 19/094,685

(22) PCT Filed: Jun. 29, 2023
(86) PCT No.: PCT/CN2023/103608

§ 371 Date: Jul. 2, 2026

(30) Foreign Application Priority Data
Sep. 28, 2022 (CN) 202211189649.3

(51) Int. Cl. H04W 64/00; H04W 24/08

(52) U.S. Cl. CPC H04W 64/00; H04W 24/08

(57) ABSTRACT

A terminal includes a memory storing a program and a processor configured to execute the program to obtain a positioning request for a target terminal, determine positioning wireless resource configuration information and feedback configuration information in response to the positioning request, send the positioning wireless resource configuration information to at least one target anchor node, send the positioning wireless resource configuration information and the feedback configuration information to the target terminal, send at least one of a positioning parameter signal or a positioning wireless frame to the target terminal, and receive target information reported by the target terminal based on the feedback configuration information.

The target information includes a position of the target terminal or a positioning-related measurement quantity corresponding to the terminal and a positioning-related measurement quantity corresponding to each target anchor node that are used to determine the position of the target terminal.

This application claims priority to Chinese Application No. 202211189649.3, filed with the China Patent Office on Sep. 28, 2022 and titled “Positioning Method and Terminal,” the entire content of which is incorporated herein by reference.

### TECHNICAL FIELD

The present disclosure generally relates to the field of positioning technologies and, more particularly, to a positioning method and terminal.

### BACKGROUND

At present, with the large-scale commercial deployment of 5G networks, a variety of applications and services that require high-speed, low-latency and highly reliable wireless connections have emerged in large numbers, for example, emerging scenarios such as smart manufacturing, smart homes, virtual reality (VR)/augmented reality (AR)/extended reality (XR), and Industrial Internet 4.0. To meet the wireless communication needs in these emerging scenarios, relevant standardization organizations or groups have formulated new short-range wireless communication system standards to provide wireless transmission capabilities that meet short-range business needs. At this stage, as one of the evolutionary technologies of new short-range wireless communication systems, positioning functions urgently need to be supplemented and supported.

### SUMMARY

In view of the above, the present disclosure provides a positioning method and terminal, including the following.

A terminal that is a first terminal, including:
a memory configured to store a program; and
a processor configured to execute the program stored in the memory, and the program, when executed by the processor, configures the processor to:
obtain a positioning request for a target terminal;
determine positioning wireless resource configuration information and feedback configuration information in response to the positioning request;
send the positioning wireless resource configuration information to at least one target anchor node;
send the positioning wireless resource configuration information and the feedback configuration information to the target terminal;
send a positioning parameter signal and/or a positioning wireless frame to the target terminal; and
receive target information reported by the target terminal based on the feedback configuration information.

The target information includes a positioning-related measurement quantity corresponding to the first terminal and a positioning-related measurement quantity corresponding to each target anchor node, or the target information includes a position of the target terminal.

The positioning-related measurement quantity corresponding to the first terminal and the positioning-related measurement quantity corresponding to each target anchor node are used to determine the position of the target terminal.

In the terminal, the at least one target anchor node is selected from a plurality of anchor nodes, where the plurality of anchor nodes are terminals registered with the first terminal.

Correlation degrees between the at least one target anchor node and the target terminal are higher than correlation degrees between non-target anchor nodes of the plurality of anchor nodes and the target terminal.

In the terminal, that the correlation degrees between the at least one target anchor node and the target terminal are higher than the correlation degrees between the non-target anchor nodes of the plurality of anchor nodes and the target terminal, includes:
signal strength between the at least one target anchor node and the target terminal is greater than the signal strength between the non-target anchor nodes and the target terminal.

In the terminal, optionally, the program, when executed by the processor, further configure the processor to:
send configuration information of each anchor node to the target terminal;
receive the signal strength between the target terminal and each anchor node sent by the anchor node; and
determine the at least one target anchor node based on the signal strength between the target terminal and each anchor node.

In the terminal, optionally, the program, when executed by the processor, further configure the processor to:
send configuration information of each anchor node to the target terminal;
receive a link establishment success signal sent by each anchor node, wherein the link establishment success signal sent by the anchor node indicates that the anchor node has established a link with the target terminal;
send reference signal configuration information for link quality measurement to the target terminal and each anchor node;
receive the signal strength between the target terminal and each anchor node; and determine the at least one target anchor node based on the signal strength between the target terminal and each anchor node.

In the terminal, optionally, the program, when executed by the processor, further configure the processor to:
send first reporting resource configuration information to each anchor node and receive position and status information reported by each anchor node according to a target period based on a first target frequency; or
send second reporting resource configuration information to each anchor node and receive the position and status information reported by each anchor node based on a second target frequency.

In the terminal, optionally, the plurality of anchor nodes include at least two types: static anchor nodes and dynamic anchor nodes. The dynamic anchor nodes are mobile terminals.

The program, when executed by the processor, further configures the processor to:
in the case where the at least one target anchor node selected from the plurality of anchor nodes includes M dynamic anchor nodes, send an auxiliary positioning request to each of the M dynamic anchor nodes; and
when first information fed back by the M dynamic anchor nodes is received, perform sending the positioning wireless resource configuration information to the at least one target anchor node.

In the terminal, optionally, the program, when executed by the processor, further configure the processor to:
broadcast anchor node query information; and
receive an anchor node registration request sent by a first device, and record relevant information of the first device carried in the anchor node registration request.

The relevant information at least includes an identification identifier and position information of the first device.

The anchor node registration request is sent by the first device to the first terminal after receiving the anchor node query information.

In the terminal, optionally, the relevant information further include the anchor node type of the first device.

A terminal that is a second terminal, and the second terminal is a target anchor node selected from a plurality of anchor nodes. The plurality of anchor nodes are terminals that have registered with a first terminal. A correlation degree between the target anchor node and the target terminal is higher than correlation degrees between non-target anchor nodes among the plurality of anchor nodes and the target terminal. The second terminal includes:
a memory configured to store a program;
a processor configured to execute the program stored in the memory. The program, when executed by the processor, configures the processor to:
receive positioning wireless resource configuration information sent by the first terminal; and send a positioning reference signal and/or a positioning wireless frame to the target terminal according to the positioning wireless resource configuration information.

In the terminal, optionally, the correlation degree between the target anchor node and the target terminal is higher than the correlation degree between any non-target anchor node among the plurality of anchor nodes and the target terminal, includes:
the signal strength between the target anchor node and the target terminal is greater than the signal strength between any non-target anchor node and the target terminal.

In the terminal, optionally, when executed by the processor, the program further configures the processor to:
receive a link establishment request sent by the target terminal;
measure the signal strength of an access signal carrying the link establishment request;
send the signal strength to the first terminal; and
receive link establishment confirmation information sent by the first terminal, and establish a link with the target terminal, thereby indicating that the second terminal has been determined to be the target anchor node.

In the terminal, optionally, when executed by the processor, the program further configures the processor to:
establish a link with the target terminal; and
receive reference signal configuration information for link quality measurement sent by the first terminal.

The reference signal configuration information is used to determine the signal strength between the target terminal and each of the anchor nodes.

In the terminal, optionally, when executed by the processor, the program further configures the processor to:
send a reference signal to the target terminal based on the reference signal configuration information; and
receive link establishment confirmation information sent by the first terminal, thereby indicating that the second terminal has been determined to be the target anchor node.

In the terminal, optionally, when executed by the processor, the program further configures the processor to:
receive a reference signal sent by the target terminal based on the reference signal configuration information;
calculate the signal strength between the target terminal and the second terminal based on the reference signal sent by the target terminal;
report the signal strength between the target terminal and the second terminal to the first terminal; and
receive link establishment confirmation information sent by the first terminal, thereby indicating that the second terminal has been determined to be the target anchor node.

In the terminal, optionally, when executed by the processor, the program further configures the processor to:
receive first reporting resource configuration information sent by the first terminal; and, based on the first reporting resource configuration information, report the location and status information of the second terminal to the first terminal according to a target period and a first target frequency; or
receive second reporting resource configuration information sent by the first terminal; and, based on the second reporting resource configuration information, report the location and status information of the second terminal to the first terminal according to a second target frequency.

In the terminal, optionally, the anchor node includes at least two types: static anchor nodes and a dynamic anchor nodes.

A dynamic anchor node is a mobile terminal;

When executed by the processor, the program further configures the processor to:
in the case where the second terminal is a dynamic anchor node, receive an auxiliary positioning request sent by the first terminal; and
if auxiliary positioning conditions are met, provide feedback to the first terminal with first information; wherein the first information indicates that the anchor node is capable of being used for auxiliary positioning.

In the terminal, optionally, when executed by the processor, the program further configures the processor to:
receive an anchor node query request broadcast by the first terminal;
send an anchor node registration request to the first terminal, wherein the anchor node registration request carries relevant information regarding the second terminal, and the relevant information includes at least: an identification identifier and location information of the second terminal.

In the terminal, optionally, the relevant information further includes the anchor node type of the second terminal.

A terminal that is a target terminal, including:
a memory configured to store a program; and
a processor configured to execute the program stored in the memory. The program, when executed by the processor, configures the processor to:
receive positioning wireless resource configuration information and feedback configuration information sent by a first terminal;
receive a positioning reference signal and/or a positioning wireless frame sent by the first terminal and a positioning reference signal and/or a positioning wireless frame sent by at least one target anchor node based on the wireless resource configuration information;
calculate a positioning-related measurement quantity corresponding to the first terminal according to the positioning reference signal and/or positioning wireless frame sent by the first terminal, and calculate a positioning-related measurement quantity corresponding to the at least one target anchor node according to the positioning reference signal and/or positioning wireless frame sent by the at least one target anchor node; and
report target information to the first terminal based on the feedback configuration information.

The target information includes the positioning-related measurement quantity corresponding to the first terminal and the positioning-related measurement quantity corresponding to the at least one target anchor node; or, the target information includes a position of the target terminal.

The positioning-related measurement quantity corresponding to the first terminal and the positioning-related measurement quantity corresponding to the at least one target anchor node are used to determine the position of the target terminal.

In the terminal, optionally, the at least one target anchor node is selected from a plurality of anchor nodes; where the plurality of anchor nodes includes terminals that have registered with the first terminal.

The correlation degree between the target anchor node and the target terminal is higher than the correlation degree between any non-target anchor node among the plurality of anchor nodes and the target terminal.

In the terminal, optionally, the condition that the correlation degree between the target anchor node and the target terminal is higher than the correlation degree between any non-target anchor node among the plurality of anchor nodes and the target terminal includes:

the signal strength between the target anchor node and the target terminal is greater than the signal strength between the non-target anchor node and the target terminal.

In the terminal, optionally, when executed by the processor, the program further configures the processor to:
receive configuration information for each of the anchor nodes sent by the first terminal;
send a link establishment request to each of the anchor nodes based on the configuration information for each of the anchor nodes; and
receive a link establishment success signal fed back by the anchor nodes.

In the terminal, optionally, when executed by the processor, the program further configures the processor to:
receive configuration information for each of the anchor nodes sent by the first terminal;
establish a link with the anchor nodes based on the configuration information of the anchor nodes; and
receive reference signal configuration information for link quality measurement sent by the first terminal.

The reference signal configuration information is used to determine the signal strength between the target terminal and each of the anchor nodes.

In the terminal, optionally, when executed by the processor, the program further configures the processor to:
based on the reference signal configuration information, receive reference signals for link quality measurement sent by each of the anchor nodes;
calculate the signal strength between the target terminal and the anchor nodes based on the reference signals sent by the anchor nodes; and
feed back the signal strength between the target terminal and each of the anchor nodes to the first terminal.

In the terminal, optionally, when executed by the processor, the program further configures the processor to:
based on the reference signal configuration information, send reference signals for link quality measurement to the anchor nodes.

The reference signals are used to calculate the signal strength between the target terminal and the anchor nodes.

A positioning method applied to a first terminal, including:
obtaining a positioning request for a target terminal;
determining positioning wireless resource configuration information and feedback configuration information in response to the positioning request;
sending the positioning wireless resource configuration information to at least one target anchor node;
sending the positioning wireless resource configuration information and the feedback configuration information to a target terminal;
sending a positioning parameter signal and/or a positioning wireless frame to the target terminal; and
receiving target information reported by the target terminal based on the feedback configuration information.

The target information includes a positioning-related measurement quantity corresponding to the first terminal and a positioning-related measurement quantity corresponding to each target anchor node, or the target information includes a position of the target terminal.

The positioning-related measurement quantity corresponding to the first terminal and the positioning-related measurement quantity corresponding to each target anchor node are used to determine the position of the target terminal.

A positioning method applied to a second terminal. The second terminal is a target anchor node selected from a plurality of anchor nodes. The plurality of anchor nodes are terminals that have registered with the first terminal. A correlation degree between the target anchor node and the target terminal is higher than correlation degrees between non-target anchor nodes among the plurality of anchor nodes and the target terminal. The method includes:
receiving positioning wireless resource configuration information sent by a first terminal; and
sending a positioning reference signal and/or a positioning wireless frame to a target terminal according to the positioning wireless resource configuration information.

A positioning method applied to a target terminal, including:
receiving positioning wireless resource configuration information and feedback configuration information sent by a first terminal;
receiving a positioning reference signal and/or a positioning wireless frame sent by the first terminal and a positioning reference signal and/or a positioning wireless frame sent by at least one target anchor node based on the wireless resource configuration information;
calculating a positioning-related measurement quantity corresponding to the first terminal according to the positioning reference signal and/or positioning wireless frame sent by the first terminal, and calculating a positioning-related measurement quantity corresponding to the at least one target anchor node according to the positioning reference signal and/or positioning wireless frame sent by the at least one target anchor node; and
reporting target information to the first terminal based on the feedback configuration information.

The target information includes the positioning-related measurement quantity corresponding to the first terminal and the positioning-related measurement quantity corresponding to the at least one target anchor node; or, the target information includes a position of the target terminal.

The positioning-related measurement quantity corresponding to the first terminal and the positioning-related measurement quantity corresponding to the at least one target anchor node are used to determine the position of the target terminal.

The present disclosure provides a positioning method and a terminal. Upon receiving a positioning request directed at a target terminal, the first terminal responds to the request by determining positioning wireless resource configuration information and feedback configuration information. The first terminal transmits the positioning wireless resource configuration information to at least one target anchor node, and transmits both the positioning wireless resource configuration information and the feedback configuration information to the target terminal. The first terminal transmits positioning parameter signals and/or positioning wireless frames to the target terminal. Subsequently, the first terminal receives target information reported by the target terminal based on the feedback configuration information. The target information includes the positioning-related measurement quantity corresponding to the first terminal and the positioning-related measurement quantity corresponding to the at least one target anchor node; or, the target information includes a position of the target terminal. The positioning-related measurement quantity corresponding to the first terminal and the positioning-related measurement quantity corresponding to the at least one target anchor node are used to determine the position of the target terminal. By configuring positioning wireless resources and feedback-related information for the target terminal and the target anchor nodes using the first terminal, the present disclosure allows the target terminal to measure the positioning-related quantities associated with the first terminal and the respective target anchor nodes. Consequently, the position of the target terminal can be determined based on the obtained positioning-related measurements, thereby achieving high-precision positioning of the target terminal.

### BRIEF DESCRIPTION OF THE DRAWINGS

To more clearly illustrate the technical solutions of the embodiments of the present disclosure, the drawings needed for use in the description of the embodiments will be briefly introduced below. The drawings described below are some embodiments of the present disclosure. For those of ordinary skill in the art, other drawings can be obtained according to the provided drawings without any creative work.

FIG. 1A is a schematic structural diagram of a first terminal consistent with embodiments of the present disclosure

FIG. 1B is a flow chart of a positioning method consistent with embodiments of the present disclosure.

FIG. 2A is a schematic structural diagram of a second terminal consistent with embodiments of the present disclosure

FIG. 2B is a flow chart of another positioning method consistent with embodiments of the present disclosure.

FIG. 3A is a schematic structural diagram of a target terminal consistent with embodiments of the present disclosure

FIG. 3B is a flow chart of another positioning method consistent with embodiments of the present disclosure.

FIG. 4 is a flow chart of another positioning method consistent with embodiments of the present disclosure.

FIG. 5 is a flow chart of selecting at least one target anchor node from multiple anchor nodes consistent with embodiments of the present disclosure.

FIG. 6 is another flow chart of selecting at least one target anchor node from multiple anchor nodes consistent with embodiments of the present disclosure.

FIG. 7 is a flow chart for a first terminal to monitor each anchor node consistent with embodiments of the present disclosure.

FIG. 8 is another flow chart for a first terminal to monitor each anchor node consistent with embodiments of the present disclosure.

FIG. 9 is a schematic structural diagram of a positioning device consistent with embodiments of the present disclosure.

FIG. 10 is a schematic structural diagram of another positioning device consistent with embodiments of the present disclosure.

FIG. 11 is a schematic structural diagram of another positioning device consistent with embodiments of the present disclosure.

### DETAILED DESCRIPTION OF THE EMBODIMENTS

Embodiments of the present disclosure are described hereinafter with reference to the accompanying drawings. The described embodiments are only some of the embodiments of the present disclosure, and not all of the embodiments. Based on the embodiments in the present disclosure, all other embodiments obtained by those skilled in the art without creative work are within the scope of the present disclosure.

The present disclosure provides a positioning method. The positioning method may be used in a terminal device (referred to as a first terminal). The first terminal may be a device with management functions in a short-range wireless communication system. As an example, the first terminal may be a wireless access point (AP). Of course, the first terminal may also be other devices as long as it is able to implement the positioning method provided by the present disclosure.

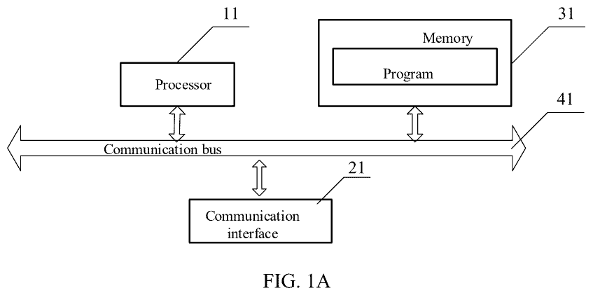

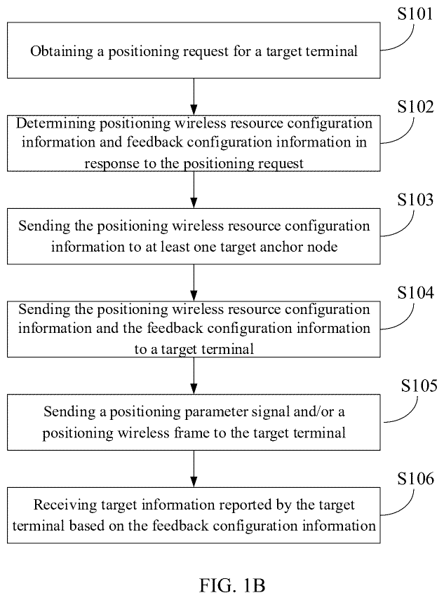

As shown in FIG. 1A to FIG. 1B, FIG. 1A is a schematic structural diagram of a first terminal consistent with embodiments of the present disclosure, and FIG. 1B is a flow chart of a positioning method consistent with embodiments of the present disclosure. As shown in FIG. 1A, in one embodiment, the first terminal may include: at least one processor 11, at least one communication interface 21, at least one memory 31, and at least one communication bus 41.

In one embodiment of the present disclosure, the number of the at least one processor 11, the number of the at least one communication interface 21, the number of the at least one memory 31, or the number of the at least one communication bus 41 may be at least one. The at least one processor 11, the at least one communication interface 21, and the at least one memory 31 may communicate with each other through the at least one communication bus 41.

The at least one processor 11 may be a central processing unit (CPU), or an application specific integrated circuit (ASIC), or one or more integrated circuits configured to implement the embodiments of the present disclosure, etc.

The at least one memory 31 may include a high-speed RAM memory, and may also include a non-volatile memory, such as at least one disk memory.

The at least one memory 31 may be configured to store a program, and the at least one processor 11 may be configured to execute the program stored in the at least one memory 31. When the program is executed by the at least one processor 11, the at least one processor 11 may be configured to execute the positioning method shown in FIG. 1B. The positioning method includes S101 to S106.
S101, a positioning request for a target terminal is obtained.

In one embodiment, the positioning request for the target terminal may be triggered by a user performing a specified operation on the first terminal.

Or, in another embodiment, the positioning request for the target terminal may be generated by other devices and sent to the first terminal. That is, the first terminal may receive the positioning request for the target terminal sent by other devices.
S102, in response to the positioning request, positioning wireless resource configuration information and feedback configuration information are determined.

The positioning wireless resource configuration information may be used to configure a target anchor node and a target terminal, mainly including configuring wireless transmission resources required for positioning the target terminal. The positioning wireless resource configuration information may include but is not limited to information including: pilot, the number and period of positioning wireless frames, the frequency hopping mode related to the positioning algorithm, the positioning reference signal and/or the positioning wireless frame, etc. Optionally, the first terminal may determine the wireless transmission resources required for positioning based on information such as positioning accuracy requirements, system configuration (i.e., configuration of the short-range wireless communication system), or network topology (i.e., network topology of the short-range wireless communication system).

The feedback configuration information may be used to configure the target terminal, including but not limited to: the positioning-related measurement quantity that the target terminal needs to calculate, the feedback transmission format (i.e., the transmission format when the target terminal feeds back information to the first terminal), or other information.

After the first terminal determines the positioning wireless resource configuration information and the feedback configuration information, it may need to perform the following signaling interaction process with the target anchor node and the target terminal:
S103: the positioning wireless resource configuration information is sent to at least one target anchor node.

In one embodiment, the positioning wireless resource configuration information may be sent to only one target anchor node. Or, in some other embodiments, the positioning wireless resource configuration information may be sent to multiple (i.e., two or more) target anchor nodes. By sending the above positioning wireless resource configuration information to the at least one target anchor node, the at least one target anchor node may send a positioning reference signal and/or a positioning wireless frame to the target terminal based on the pilot, the number and period of positioning wireless frames, the frequency hopping mode, etc., specified by the positioning wireless resource configuration information.

The at least one target anchor node may be selected from a plurality of anchor nodes. Each of the plurality of anchor nodes may be a terminal with an auxiliary positioning function.
S104, the positioning wireless resource configuration information and feedback configuration information are sent to the target terminal.

By sending the positioning wireless resource configuration information to the target terminal, the target terminal may be able to receive the positioning reference signal and/or the positioning wireless frame based on the pilot, the number and period of positioning wireless frames, the frequency hopping mode, etc. specified by the positioning wireless resource configuration information.

By sending the feedback configuration information to the target terminal, the target terminal may be able to determine the positioning-related measurement quantity to be calculated based on the feedback configuration information, and the feedback transmission format required to report information to the first terminal.

The execution order of S103 and S104 is not limited in the present disclosure. In one embodiment, S103 may be executed first, and then S104 may be executed. Or, in some other embodiments, S104 may be executed first, and then S103 may be executed. Or, in yet some other embodiments, S103 and S104 may be executed simultaneously.
S105, the positioning parameter signal and/or the positioning wireless frame are sent to the target terminal.

The first terminal may send the positioning parameter signal and/or the positioning wireless frame to the target terminal based on the pilot, a number and a period of positioning wireless frames, a frequency hopping mode, etc., specified by the above-mentioned wireless resource configuration information.
S106, target information reported by the target terminal is received based on the feedback configuration information.

The target information may include: the positioning-related measurement quantity corresponding to the first terminal and the positioning-related measurement quantity corresponding to each target anchor node. Or, in some other embodiments, the target information may include: the position of the target terminal.

The positioning-related measurement quantity corresponding to the first terminal may be calculated by the target terminal according to the positioning parameter signal and/or positioning wireless frame sent by the first terminal.

The positioning-related measurement quantity corresponding to one target anchor node may be calculated by the target terminal according to the positioning parameter signal and/or positioning wireless frame sent by the target anchor node. That is, the positioning-related measurement quantity corresponding to the j-th target anchor node (the j-th target anchor node is any one of the at least one target anchor node) may be calculated by the target terminal according to the positioning parameter signal and/or positioning wireless frame sent by the j-th target anchor node.

The positioning-related measurement quantity corresponding to the first terminal and the positioning-related measurement quantity corresponding to each target anchor node may be used to determine the position of the target terminal.

After the target terminal calculates the positioning-related measurement quantity corresponding to the first terminal and the positioning-related measurement quantity corresponding to each target anchor node, the positioning-related measurement quantity corresponding to the first terminal and the positioning-related measurement quantity corresponding to each target anchor node may be directly fed back to the first terminal. The first terminal may calculate the position of the target terminal according to the positioning-related measurement quantity corresponding to the first terminal and the positioning-related measurement quantity corresponding to each target anchor node.

Alternatively, in another embodiment, after the target terminal calculates the positioning-related measurement quantity corresponding to the first terminal and the positioning-related measurement quantity corresponding to each target anchor node, the position of the target terminal may be calculated according to the positioning-related measurement quantity corresponding to the first terminal and the positioning-related measurement quantity corresponding to each target anchor node, and the calculated position of the target terminal may be fed back to the first terminal.

The positioning-related measurement quantity may include but is not limited to at least one of: channel state information (CSI), signal propagation time (ToF), signal arrival time difference (TDoA), received signal strength (RSS), radio frequency fingerprint (RF Fingerprint), or an angle of arrival (AoA) and an angle of departure (AoD) representing the angle direction of the signal.

The first terminal provided in the present embodiment may configure the positioning wireless resources and feedback-related information for the target terminal and the at least one target anchor node, such that the target terminal is able to measure the positioning-Attorney related measurement quantity corresponding to the first terminal and the positioning-related measurement quantity corresponding to each target anchor node. The obtained positioning-related measurement quantity may be used to determine the position of the target terminal, thereby realizing high-precision positioning of the target terminal.

In an optional embodiment, the plurality of anchor nodes may be terminals registered with the first terminal. That is, each of the plurality of anchor nodes may be a terminal with the auxiliary positioning function that has been registered with the first terminal.

Optionally, in one embodiment, at least one anchor node (that is, N anchor nodes, where N is an integer greater than or equal to 1) may be selected from the plurality of anchor nodes as the N target anchor nodes according to the correlation degree between each anchor node in the plurality of anchor nodes and the target terminal.

The correlation degree between the at least one target anchor node and the target terminal may be higher than the correlation degrees between non-target anchor nodes (i.e., anchor nodes other than the target anchor nodes in the plurality of anchor nodes) and the target terminal.

The plurality of anchor nodes may be sorted in a descending order according to the correlation degree with the target terminal, and the top N anchor nodes in terms of the correlation degree with the target terminal may be selected as the N target anchor nodes.

Alternatively, in some other embodiments, anchor nodes whose correlation degree with the target terminal is greater than the correlation degree threshold may be selected as the N target anchor nodes. Optionally, when there is no anchor node whose correlation degree with the target terminal is greater than the correlation degree threshold, the top N anchor nodes in terms of the correlation degree with the target terminal may be selected as the N target anchor nodes.

Optionally, the correlation degree between one anchor node and the target terminal may be characterized by the signal strength between the anchor node and the target terminal. When the signal strength between the anchor node and the target terminal is stronger, the correlation degree between the anchor node and the target terminal may be greater. When the signal strength between the anchor node and the target terminal is weaker, the correlation degree between the anchor node and the target terminal may be smaller.

Correspondingly, the signal strength between the N target anchor nodes and the target terminal may be greater than the signal strength between the non-target anchor nodes and the target terminal.

In one embodiment, when the program stored in the at least one memory 31 is executed by the at least one processor 11, the at least one processor 11 may be further configured to perform:
sending the configuration information of each anchor node to the target terminal, where the configuration information of one anchor node may include but is not limited to: identification information of the anchor node (for example, ID), an access signal format of the anchor node, etc.;
receiving the signal strength between the target terminal and each anchor node sent by the anchor node, where the signal strength between the target terminal and the i-th anchor node (the i-th anchor node is any one of the plurality of anchor nodes) may be obtained by measuring the strength of the access signal carrying the link establishment request after the i-th anchor node receives the link establishment request sent by the target terminal and the target terminal may send the link establishment request to the i-th anchor node according to the configuration information of the i-th anchor node after receiving the configuration information of the i-th anchor node sent by the first terminal; and
determining the target anchor nodes based on the signal strength between the target terminal and each anchor node.

The first terminal may sort the plurality of anchor nodes in the descending order according to the signal strength between them and the target terminal, and determine the first N anchor nodes as the N target anchor nodes.

Or, in another embodiment, the first terminal may determine anchor nodes whose signal strength between them and the target terminal is greater than the strength threshold as the target anchor nodes. When the number of anchor nodes whose signal strength with the target terminal is greater than the strength threshold is greater than N, the first N anchor nodes whose signal strength with the target terminal is greater than the strength threshold may be selected as the N target anchor nodes. When there is no anchor node whose signal strength with the target terminal is greater than the strength threshold, the first N anchor nodes may be selected as the N target anchor nodes.

In one embodiment, when the program stored in the at least one memory 31 is executed by the at least one processor 11, the at least one processor 11 may be further configured to perform:
after determining the target anchor nodes, sending link establishment confirmation information to the target anchor nodes, such that the target anchor nodes establish links with the target terminal.

In the present embodiment, the target anchor nodes may be determined in the process of establishing the links between the target terminal and the plurality of anchor nodes.

In another optional embodiment, the target anchor nodes may be determined after the target terminal establishes the links between the target terminal and the plurality of anchor nodes. Correspondingly, when the program stored in the at least one memory 31 is executed by the at least one processor 11, the at least one processor 11 may be further configured to perform:
sending configuration information of each anchor node to the target terminal, where the configuration information of one anchor node may include but is not limited to identification information of the anchor node (for example, ID), the access signal format of the anchor node, etc., and the target terminal may send a link establishment request to the i-th anchor node according to the configuration information of the i-th anchor node after receiving the configuration information of the i-th anchor node sent by the first terminal;
receiving a link establishment success signal sent by each anchor node, where the link establishment success signal sent by the anchor node indicates that the anchor node has established a link with the target terminal, and the i-th anchor node may send the link establishment success signal to the first terminal or may also send the link establishment success signal to the target terminal after the i-th anchor node establishes the link with the target terminal; and
sending reference signal configuration information for link quality measurement to the target terminal and each anchor node, where, after the first terminal receives the link establishment success signal sent by at least one anchor node, it may send reference signal configuration information for link quality measurement to one anchor node (for example, the i-th anchor node) that sent the link establishment success signal, and the target terminal, respectively.

Optionally, the i-th anchor node may send a designated reference signal to the target terminal based on the reference signal configuration information, and the target terminal may calculate the signal strength between the target terminal and the i-th anchor node based on the reference signal specified by the received reference signal configuration information. After the target terminal obtains the signal strength between the target terminal and each anchor node, it may send the signal strength between the target terminal and each anchor node to the first terminal.

Optionally, in some other embodiments, the target terminal may send a designated reference signal to each anchor node based on the reference signal configuration information, and each anchor node may calculate the signal strength between itself and the target terminal based on the reference signal specified by the received reference signal configuration information. That is, the i-th anchor node may calculate the signal strength between the i-th anchor node and the target terminal based on the reference signal specified by the received reference signal configuration information. Each anchor node may send the calculated signal strength between itself and the target terminal to the first terminal. That is, after the i-th anchor node obtains the signal strength between the target terminal and the i-th anchor node, it may send the signal strength between the target terminal and the i-th anchor node to the first terminal.

Optionally, the format of the access signal carrying the link establishment request and the format of the reference signal specified by the reference signal configuration information may multiplex the format of the reference signal defined by the air interface of the existing short-range wireless communication system (for example, a reference signal defined for data transmission, which is used for link recovery, link quality monitoring, etc.).

Optionally, in some other embodiments, the format of the access signal carrying the link establishment request may be a format dedicated to positioning, and the format of the reference signal specified by the reference signal configuration information may also be a format dedicated to positioning.

The signal strength between the target terminal and each anchor node may be received.

Optionally, the at least one processor 11 may be configured to receive the signal strength between the target terminal and each anchor node fed back by the target terminal.

Optionally, in some other embodiments, the at least one processor 11 may be configured to receive the signal strength between the target terminal and each anchor node fed back by each anchor node.

The target anchor nodes may be determined based on the signal strength between the target terminal and each anchor node.

In one embodiment, when the program stored in the at least one memory 31 is executed by the at least one processor 11, the at least one processor 11 may be further configured to perform:
after determining the target anchor nodes, sending link establishment confirmation information to the target anchor nodes, to ensure that the target anchor can be used for subsequent auxiliary positioning (i.e., S101-S106 in previous embodiments).

In some embodiments, for the non-target anchor nodes, since they have not received link establishment confirmation information, they may not be used for subsequent auxiliary positioning. To reduce power consumption, when one non-target anchor node has not received link establishment confirmation information within a preset time, it may enter a low power consumption state, such as a dormant state or a sleeping state. Correspondingly, when the program stored in the at least one memory 31 is executed by the at least one processor 11, the at least one processor 11 may be further configured to perform:
before sending the configuration information of each anchor node to the target terminal, waking up each anchor node, and then sending the configuration information of each anchor node to the target terminal.

In the present disclosure, the target anchor nodes may not be fixed, but may be selected in real time. For example, the above process of selecting the target anchor nodes may be triggered when the positioning request for the target terminal is obtained, such that the optimal anchor nodes for auxiliary positioning may be obtained in real time, thereby further improving the positioning accuracy of the target terminal.

In an optional embodiment, to keep the first terminal updated with the position and status of the plurality of anchor nodes, when the program stored in the at least one memory 31 is executed by the at least one processor 11, the at least one processor 11 may be further configured to perform:
sending first reporting resource configuration information to each anchor node respectively, where the first reporting resource configuration information indicates the period (for the convenience of description and distinction, recorded as the target period) and frequency (for the convenience of description and distinction, recorded as the first target frequency) of the anchor nodes reporting the position and status information to the first terminal; and
receiving the position and status information reported by the anchor nodes according to the target period based on the first target frequency, where, after the i-th anchor node receives the first reporting resource configuration information sent by the first terminal, it may use the first target frequency to periodically report the position and status information of the i-th anchor node to the first terminal, and the reporting period may be the target period.

The status information of one anchor node may represent that the anchor node is online. When the anchor node is not online (for example, power failure or failure, or blocked, etc.), the position and status information may not be reported to the anchor node, and auxiliary positioning cannot be performed. Correspondingly, the plurality of anchor nodes may be online terminals that have registered with the first terminal.

The first reporting resource configuration information sent to different anchor nodes may specify different first target frequencies. Or, the first reporting resource configuration information sent to different anchor nodes may specify the same first target frequency, while the time of reporting the position and status information may be different. That is, different anchor nodes may report at different first target frequencies, or different anchor nodes may report at the same first target frequency while at different reporting times. Therefore, it may be possible to avoid collision of information reported by different anchor nodes and failure of reporting information.

In one embodiment, when the program stored in the at least one memory 31 is executed by the at least one processor 11, the at least one processor 11 may be further configured to perform:
sending stop-reporting configuration information to each anchor node respectively, such that each anchor node stops reporting position and status information to the first terminal.

The first terminal may send the stop-reporting configuration information to each anchor node respectively when conditions are met. Satisfying the conditions may include but is not limited to any of: the number of cycles for each anchor node to report position and status information to the first terminal reaches a preset number of cycles; an interrupt request with a priority greater than the target priority is obtained; a target event is detected, etc.

In this embodiment, the first terminal may configure each anchor node to periodically report the position and status information of the anchor node to the first terminal.

In another embodiment, the first terminal may configure each anchor node to report the position and status information of the anchor node to the first terminal once. Correspondingly, when the program stored in the at least one memory 31 is executed by the at least one processor 11, the at least one processor 11 may be further configured to perform:
sending second reporting resource configuration information to each anchor node, where the second reporting resource configuration information indicates the frequency at which the anchor nodes report the position and status information to the first terminal once (for ease of description and distinction, it is recorded as the second target frequency).

The position and status information reported by the anchor nodes may be received based on the second target frequency. After the i-th anchor node receives the second reporting resource configuration information, it may use the second target frequency to report the position and status information of the i-th anchor node to the first terminal once.

The second reporting resource configuration information sent to different anchor nodes may specify different second target frequencies. Or, the second reporting resource configuration information sent to different anchor nodes may specify the same second target frequency, but the time of reporting the position and status information for different anchor nodes may be different. That is, different anchor nodes may report at different second target frequencies, or different anchor nodes may report at the same second target frequency while the reporting time may be different.

In an optional embodiment, one terminal registered with the first terminal may be a terminal at a fixed position or a terminal at a movable position (referred to as a mobile terminal). Therefore, the plurality of anchor nodes may be divided into two types: static anchor nodes and dynamic anchor nodes. The static anchor nodes may be terminals at fixed positions, and the dynamic anchor nodes may be terminals at movable positions (for example, notebooks, mobile phones, desktop computers, etc.). Correspondingly, when the program stored in the at least one memory 31 is executed by the at least one processor 11, the at least one processor 11 may be further configured to perform:
when the at least one target anchor node selected from the plurality of anchor nodes includes M (M is less than or equal to N) dynamic anchor nodes, sending an auxiliary positioning request to each of the M dynamic anchor nodes.

When the first information fed back by the M dynamic anchor nodes is received, sending the positioning wireless resource configuration information to the at least one target anchor node may be executed.

When the M dynamic anchor nodes all feed back the first information, it may mean that each dynamic anchor node is able to be used for auxiliary positioning. That is, the at least one selected target anchor node may be used for auxiliary positioning. At this time, the auxiliary positioning process, that is, the step of sending the positioning wireless resource configuration information to the at least one target anchor node and subsequent steps, may be executed.

When the second information fed back by K (K is less than or equal to M) dynamic anchor nodes is received, it may mean that K dynamic anchor nodes cannot be used for subsequent auxiliary positioning. Therefore, it may be necessary to reselect K new anchor nodes from the plurality of anchor nodes as new target anchor nodes. The specific process of selecting K new anchor nodes may refer to the aforementioned process of selecting target anchor nodes, which will not be repeated here.

In one embodiment, when the program stored in the at least one memory 31 is executed by the at least one processor 11, the at least one processor 11 may be further configured to perform:
broadcasting anchor node query information, where the first terminal may periodically broadcast anchor node query information to discover new anchor nodes; and
receiving an anchor node registration request sent by a first device, and recording relevant information of the first device carried in the anchor node registration request, where the relevant information at least includes the identification identifier and position information of the first device and the relevant information may also include an anchor node type of the first device.

After receiving the device query information, when the first device has not registered with the first terminal, it may send the anchor node registration request to the first terminal. For example, after receiving the device query request, when the first device has an auxiliary positioning function, it may send the anchor node registration request to the first terminal.

The position information of the first device in the relevant information may be the position information of the first device relative to the first terminal. The first device may obtain the position of the first device relative to the first terminal through a third-party positioning method, such as laser ranging, Wifi positioning, etc. The first device may also obtain the position of the first device relative to the first terminal through a single-point positioning method.

Corresponding to the above-mentioned first terminal, the present disclosure also provides another terminal device (referred to as the second terminal). The second terminal may be a device dedicated to auxiliary positioning, or may not be a device dedicated to auxiliary positioning. For example, it may be a notebook, mobile phone, desktop computer or other devices.

The second terminal may be a target anchor node selected from a plurality of anchor nodes. The plurality of anchor nodes may be terminals that have registered with the first terminal. The correlation degree between the target anchor node and the target terminal may be higher than the correlation degree between non-target anchor nodes in the plurality of anchor nodes and the target terminal. The target terminal may be a terminal to be positioned.

Optionally, according to the correlation degree between each anchor node in the plurality of anchor nodes and the target terminal, at least one (denoted as N, where N is an integer greater than or equal to 1) anchor node may be selected from the multiple anchor nodes as N target anchor nodes.

The correlation degree between the target anchor node and the target terminal may be higher than the correlation degree between the non-target anchor nodes in the plurality of anchor nodes (i.e., anchor nodes other than the target anchor node in the plurality of anchor nodes) and the target terminal.

Optionally, the correlation degree between one anchor node and the target terminal may be characterized by the signal strength between the anchor node and the target terminal. When the signal strength between the anchor node and the target terminal is stronger, the correlation between the anchor node and the target terminal may be greater. When the signal strength between the anchor node and the target terminal is weaker, the correlation between the anchor node and the target terminal may be smaller.

Correspondingly, the signal strength between the target anchor node and the target terminal may be greater than the signal strength between the non-target anchor nodes and the target terminal.

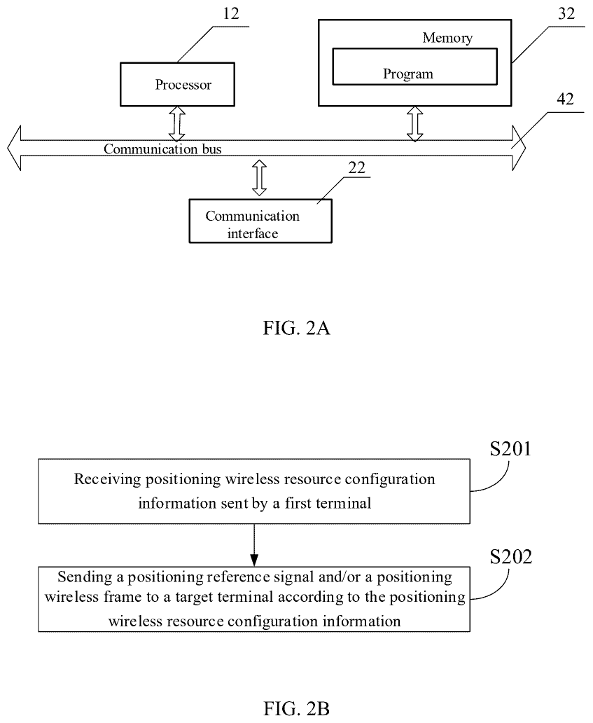

As shown in FIGS. 2A and 2B, where FIG. 2A is a schematic structural diagram of the second terminal, and FIG. 2B is a flow chart of another positioning method, consistent with embodiments of the present disclosure, the second terminal may include: at least one processor 12, at least one communication interface 22, at least one memory 32 and at least one communication bus 42.

In the embodiments of the present disclosure, the number of the at least one processor 12, the number of the at least one communication interface 22, the number of the at least one memory 32, or the number of the at least one communication bus 42 may be at least one. The at least one processor 12, the at least one communication interface 22, and the at least one memory 32 may communicate with each other through the at least one communication bus 42.

The at least one processor 12 may include a central processing unit (CPU), or an application specific integrated circuit (ASIC), or one or more integrated circuits configured to implement the embodiments of the present disclosure.

The at least one memory 32 may include a high-speed RAM memory, or may also include a non-volatile memory, such as at least one disk memory.

The at least one memory 32 may be configured to store a program, and the at least one processor 12 may be configured to execute the program stored in the at least one memory 32. When the program is executed by the at least one processor 12, the at least one processor 12 may be configured to execute S201 to S202 shown in FIG. 2B.
S201: the positioning wireless resource configuration information sent by the first terminal is received.

The positioning wireless resource configuration information may be used to configure the wireless transmission resources required for positioning the target terminal, and may include but is not limited to following information such as pilot, the number and period of positioning wireless frames, frequency hopping mode, positioning reference signal and/or positioning wireless frame, etc.
S202, a positioning reference signal and/or positioning wireless frame is sent to the target terminal according to the positioning wireless resource configuration information.

The positioning reference signal and/or positioning wireless frame may be used by the target terminal to determine the positioning-related measurement quantity corresponding to the second terminal. The positioning-related measurement quantity may be used to determine the position of the target terminal.

The positioning-related measurement quantity may include but is not limited to at least one of: channel state information (CSI), signal propagation time (ToF), signal arrival time difference (TDoA), received signal strength (RSS), RF fingerprint (RF Fingerprint), or angle of arrival (AoA) and angle of departure (AoD) that characterize the signal angle direction.

The second terminal may send the positioning reference signal and/or the positioning wireless frame to the target terminal based on the pilot, the number and period of the positioning wireless frame, the frequency hopping mode, etc. specified by the positioning wireless resource configuration information.

In some embodiments, there may be only one second terminal or a plurality of second terminals. That is, there may be at least one second terminal.

In the present disclosure, the second terminal may receive the positioning wireless resource configuration information sent by the first terminal, and send the positioning reference signal and/or a positioning wireless frame to the target terminal according to the positioning wireless resource configuration information, such that the target terminal is able to obtain the positioning-related measurement quantity corresponding to the second terminal. The positioning-related measurement corresponding to the second terminal may be used to assist in determining the position of the target terminal, thereby achieving high-precision positioning of the target terminal.

The process of the second terminal being determined as the target anchor node will be described below. When the program is executed by the at least one processor 12, the at least one processor 12 may be further configured to perform:
receiving a link establishment request sent by the target terminal, where the link establishment request may be sent by the target terminal to the second terminal according to the configuration information of the second terminal after the target terminal receives the configuration information of the second terminal sent by the first terminal and the configuration information of the second terminal may include but is not limited to identification information of the second terminal (for example, ID), access signal format of the second terminal, etc.;
measuring the signal strength of the access signal carrying the link establishment request, where the second terminal establishes synchronization with the target terminal after receiving the access signal carrying the link establishment request and then measures the signal strength of the access signal carrying the link establishment request;
sending the measured signal strength to the first terminal;
receiving the link establishment confirmation information sent by the first terminal and establishing a link with the target terminal, which indicates that the second terminal is determined as the target anchor node, where the link establishment confirmation information is sent by the first terminal when the first terminal determines that the second terminal is the target anchor node based on the signal strength sent by the second terminal. The second terminal establishes the link with the target terminal after receiving the link establishment confirmation information, indicating that the second terminal is determined as the target anchor node; and
when the second terminal does not receive the link establishment confirmation information sent by the first terminal, indicating that the second terminal is not determined as the target anchor node.

In the present embodiment, whether the second terminal is the target anchor node may be determined during the process of establishing the link between the target terminal and the second terminal.

In another optional embodiment, after the target terminal and the second terminal establish the link, it may be determined whether the second terminal is the target anchor node. Correspondingly, when the program is executed by the at least one processor 12, the at least one processor 12 may be further configured to perform:
establishing the link with the target terminal. Optionally, the second terminal may establish the link with the target terminal after receiving the link establishment request sent by the target terminal and establishing synchronization with the target terminal. After that, the link establishment success signal may be sent to the target terminal and the first terminal respectively, indicating that the second terminal has successfully established the link with the target terminal. The link establishment request may be sent by the target terminal to the second terminal according to the configuration information of the second terminal after receiving the configuration information of the second terminal sent by the first terminal.

The reference signal configuration information for link quality measurement sent by the first terminal may be received. Optionally, the reference signal configuration information may be sent by the first terminal to the second terminal after receiving the link establishment success signal sent by the second terminal.

The reference signal configuration information may be used to determine the signal strength between the target terminal and each anchor node.

Optionally, the second terminal may send the reference signal to the target terminal based on the reference signal configuration information, such that the target terminal is able to calculate the signal strength between the target terminal and the second terminal based on the received reference signal. After the target terminal obtains the signal strength between the target terminal and the second terminal, the signal strength between the target terminal and the second terminal may be sent to the first terminal, such that the first terminal determines whether the second terminal is the target anchor node based on the signal strength between the target terminal and the second terminal. Correspondingly, when the program is executed by the at least one processor 12, the at least one processor 12 may be further configured to perform:
sending the reference signal to the target terminal based on the reference signal configuration information, where the target terminal is able to calculate the signal strength between the target terminal and the second terminal based on the received reference signal by sending a reference signal to the target terminal and to send the signal strength between the target terminal and the second terminal to the first terminal; and
receiving the link establishment confirmation information sent by the first terminal, indicating that the second terminal is determined as the target anchor node, where the link establishment confirmation information is sent to the second terminal when the first terminal determines the second terminal as the target anchor node and it indicates that the second terminal is not determined as the target anchor node if the link establishment confirmation information sent by the first terminal is not received.

Optionally, the second terminal may receive the reference signal sent by the target terminal to the second terminal based on the reference signal configuration information, and the second terminal may calculate the signal strength between the second terminal and the target terminal based on the received reference signal. The second terminal may send the calculated signal strength between the second terminal and the target terminal to the first terminal. Correspondingly, when the program is executed by the at least one processor 12, the at least one processor 12 may be further configured to perform:
based on the reference signal configuration information, receiving the reference signal sent by the target terminal;
calculating the signal strength between the target terminal and the second terminal based on the reference signal sent by the target terminal;
feeding back the signal strength between the target terminal and the second terminal to the first terminal; and
receiving the link establishment confirmation information sent by the first terminal, indicating that the second terminal is determined as the target anchor node, where the link establishment confirmation information is sent to the second terminal when the first terminal determines the second terminal as the target anchor node and it indicates that the second terminal is not determined as the target anchor node if the link establishment confirmation information sent by the first terminal is not received.

Optionally, when the second terminal is not determined as the target anchor node, to reduce power consumption, the second terminal may enter a low power state, such as a dormant state or a sleeping state, if the second terminal does not receive the link establishment confirmation information sent by the first terminal within a preset time. Correspondingly, when the program is executed by the at least one processor 12, the at least one processor 12 may be further configured to perform:
receiving the wake-up signal sent by the first terminal and exiting the low power state;
after exiting the low power state, performing the step of receiving the link establishment request sent by the target terminal and subsequent steps; or,
after exiting the low power state, performing the step of establishing the link with the target terminal and the subsequent steps.

In an optional embodiment, to keep the first terminal updated with the position and status of the anchor node, when the program is executed by the at least one processor 12, the at least one processor 12 may be further configured to perform:
receiving the first reporting resource configuration information sent by the first terminal, where the first reporting resource configuration information indicates the period (for the convenience of description and distinction, recorded as the target period) and frequency (for the convenience of description and distinction, recorded as the first target frequency) of the second terminal reporting the position and status information to the first terminal; and
based on the first reporting resource configuration information, reporting the position and status information of the second terminal to the first terminal according to the target period and the first target frequency, where the second terminal may report the position and status information of the second terminal to the first terminal according to the target period and the first target frequency specified by the first reporting resource configuration information. Different second terminals may report position and status information at different first target frequencies, or different second terminals may report position and status information at the same first target frequency but at different reporting times.

The status information of the second terminal may indicate that the second terminal is online. When the second terminal is not online (for example, power failure, or failure, or obstruction, etc.), the second terminal may not report the position and status information, and cannot perform auxiliary positioning. Therefore, the plurality of anchor nodes may be: online terminals that have registered with the first terminal.

In this embodiment, the second terminal may periodically report the position and status information of the second terminal to the first terminal based on the configuration of the first terminal.

In another embodiment, the second terminal may report the position and status information of the second terminal to the first terminal once based on the configuration of the first terminal. Based on this, when the program is executed by the at least one processor 12, the at least one processor 12 may be further configured to perform:
receiving the second reporting resource configuration information sent by the first terminal, where the second reporting resource configuration information indicates the frequency (recorded as the second target frequency for the convenience of description and distinction) at which the second terminal reports the position and status information to the first terminal; and
based on the second reporting resource configuration information, reporting the position and status information of the second terminal to the first terminal according to the second target frequency. The second terminal may report the position and status information of the second terminal to the first terminal according to the second target frequency specified by the second reporting resource configuration information. Different second terminals may report the position and status information at different second target frequencies, or different second terminals may report the position and status information at the same second target frequency, but with the reporting time.

In an optional embodiment, the second terminal may be a terminal at a fixed position or a terminal at a movable position. Therefore, the second terminal may have two possible types: a static anchor node or a dynamic anchor node. A static anchor node may be a terminal at a fixed position, and a dynamic anchor node may be a terminal at a movable position (for example, a notebook, a mobile phone, a desktop, etc.). A static anchor node may be an anchor node dedicated to auxiliary positioning, or it may be an anchor node that is not dedicated to auxiliary positioning. A dynamic anchor node may be an anchor node dedicated to auxiliary positioning, or it may be an anchor node that is not dedicated to auxiliary positioning. Accordingly, when the program is executed by the at least one processor 12, the at least one processor 12 may be further configured to perform:
when the second terminal is a dynamic anchor node, receiving the auxiliary positioning request sent by the first terminal;
when the auxiliary positioning condition is met, feeding back the first information to the first terminal, where the first information indicates that the second terminal is able to be used for auxiliary positioning; and
when the auxiliary positioning condition is not met, feeding back the second information to the second terminal, where the second information indicates that the second terminal cannot be used for auxiliary positioning.

The second terminal may determine the current load of the second terminal when the second terminal receives the auxiliary positioning request sent by the first terminal, it may be determined that the auxiliary positioning condition is met when the load is less than the threshold, and it may be determined that the auxiliary positioning condition is not met when the load is not less than the threshold. Alternatively, when the second terminal receives the auxiliary positioning request sent by the first terminal, it may determine the current operating mode of the second terminal. When the operating mode is a target mode (for example, a game mode, a conference mode, etc.), it may be determined that the auxiliary positioning condition is not met. Otherwise, it may be determined that the auxiliary positioning condition is met.

The following describes the process of the second terminal registering an anchor node with the first terminal. Accordingly, when the program is executed by the at least one processor 12, the at least one processor 12 may be further configured to perform:
receiving an anchor node query request broadcast by the first terminal;
sending an anchor node registration request carrying relevant information of the second terminal to the first terminal, where the relevant information may at least include the identification identifier and position information of the second terminal, and may also include the anchor node type of the second terminal; and
after receiving the device query request, when the second terminal has an auxiliary positioning function, sending an anchor node registration request to the first terminal.

The position information of the second terminal in the relevant information may be the position information of the second terminal relative to the first terminal. The second terminal may obtain the position of the second terminal relative to the first terminal through a third-party positioning method, such as laser ranging, Wifi positioning, etc. The second terminal may also obtain the position of the second terminal relative to the first terminal through a single-point positioning method.

Corresponding to the first terminal and the second terminal, the present disclosure also provides another terminal device (that is, a target terminal).

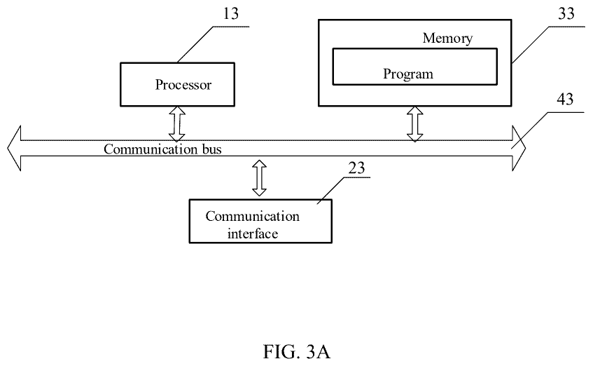

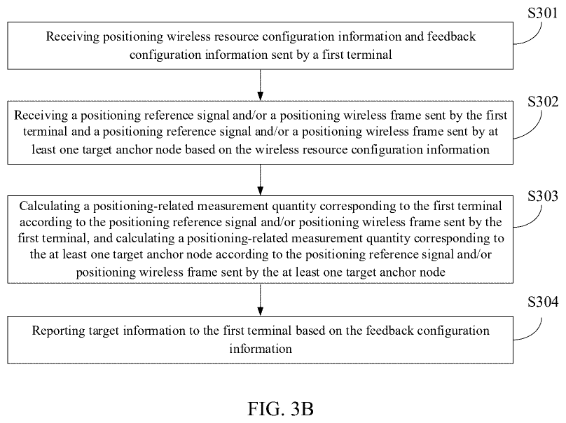

As shown in FIGS. 3A and 3B, where FIG. 3A is a schematic structural diagram of the target terminal, and FIG. 3B is a flow chart of another positioning method, consistent with embodiments of the present disclosure, the target terminal may include: at least one processor 13, at least one communication interface 23, at least one memory 33 and at least one communication bus 42.

In the embodiments of the present disclosure, the number of the at least one processor 13, the number of the at least one communication interface 23, the number of the at least one memory 33, or the number of the at least one communication bus 43 may be at least one. The at least one processor 13, the at least one communication interface 23, and the at least one memory 33 may communicate with each other through the at least one communication bus 42.

The at least one processor 13 may include a central processing unit (CPU), or an application specific integrated circuit (ASIC), or one or more integrated circuits configured to implement the embodiments of the present disclosure.

The at least one memory 33 may include a high-speed RAM memory, or may also include a non-volatile memory, such as at least one disk memory.

The at least one memory 33 may be configured to store a program, and the at least one processor 13 may be configured to execute the program stored in the at least one memory 33. When the program is executed by the at least one processor 13, the at least one processor 13 may be configured to execute S301 to S304 shown in FIG. 3B.
S301: Receive positioning wireless resource configuration information and feedback configuration information sent by the first terminal.

The positioning wireless resource configuration information may be used to configure the wireless transmission resources required for positioning the target terminal, and may include but is not limited to following information: pilot, number and period of positioning wireless frames, frequency hopping modes, positioning reference signals and/or positioning wireless frame, etc.

The feedback configuration information may include but is not limited to: a positioning-related measurement quantity that the target terminal needs to calculate, a feedback transmission format (i.e., the transmission format when the target terminal feeds back information to the first terminal), etc.
S302: Based on the wireless resource configuration information, receive the positioning reference signal and/or positioning wireless frame sent by the first terminal, and the positioning reference signal and/or positioning wireless frame sent by at least one target anchor node.

The target terminal may receive the positioning reference signal and/or positioning wireless frame based on the pilot, number and period of positioning wireless frames, the frequency hopping mode, etc. specified by the positioning wireless resource configuration information; and may determine the positioning-related measurement quantity that need to be calculated based on the feedback configuration information and the feedback transmission format required to report information to the first terminal.

The positioning-related measurement quantity may include but is not limited to at least one of: channel state information (CSI), signal propagation time (ToF), signal arrival time difference (TDoA), received signal strength (RSS), RF fingerprint (RF Fingerprint), or angle of arrival (AoA) and angle of departure (AoD) that characterize the angle direction of the signal.
S303: Calculate the positioning-related measurement quantity corresponding to the first terminal according to the positioning reference signal and/or positioning wireless frame sent by the first terminal, and calculate the positioning-related measurement quantity corresponding to the target anchor node according to the positioning reference signal and/or positioning wireless frame sent by the target anchor node.

In the present embodiment, the target terminal may calculate the positioning-related measurement quantity corresponding to the j-th target anchor node according to the positioning reference signal and/or positioning wireless frame sent by the j-th target anchor node.
S304: Report target information to the first terminal based on the feedback configuration information.

The target terminal may report the target information to the first terminal based on the feedback transmission format specified by the feedback configuration information.

The target information may include: the positioning-related measurement quantity corresponding to the first terminal and the positioning-related measurement quantity corresponding to each target anchor node. Or, the target information may include: the position of the target terminal.

The positioning-related measurement quantity corresponding to the first terminal and the positioning-related measurement quantity corresponding to each target anchor node may be used to determine the position of the target terminal.

After the target terminal calculates the positioning-related measurement quantity corresponding to the first terminal and the positioning-related measurement quantity corresponding to each target anchor node, the positioning-related measurement quantity corresponding to the first terminal and the positioning-related measurement quantity corresponding to each target anchor node may be directly fed back to the first terminal, and the first terminal may calculate the position of the target terminal according to the positioning-related measurement quantity corresponding to the first terminal and the positioning-related measurement quantity corresponding to each target anchor node.

Or, in another embodiment, after the target terminal calculates the positioning-related measurement quantity corresponding to the first terminal and the positioning-related measurement quantity corresponding to each target anchor node, the position of the target terminal may be calculated according to the positioning-related measurement quantity corresponding to the first terminal and the positioning-related measurement quantity corresponding to each target anchor node, and the calculated position of the target terminal may be fed back to the first terminal.

The target terminal provided in the present embodiment may measure the positioning-related measurement quantity corresponding to the first terminal and the positioning-related measurement quantity corresponding to each target anchor node based on the positioning wireless resource configuration and feedback-related information configuration of the target terminal by the first terminal. The obtained positioning-related measurements may be used to determine the position of the target terminal, thereby achieving high-precision positioning of the target terminal.

In an optional embodiment, the at least one target anchor node may be selected from a plurality of anchor nodes, and the plurality of anchor nodes may be terminals in the process of registering with the first terminal. That is, each of the plurality of anchor nodes may be a terminal with the auxiliary positioning function that has been registered with the first terminal.

Optionally, at least one anchor node (for example, N anchor nodes, where N is an integer greater than or equal to 1) may be selected from the plurality of anchor nodes as N target anchor nodes according to the correlation degree between each anchor node in the plurality of anchor nodes and the target terminal.

The correlation degree between one target anchor node and the target terminal may be higher than the correlation degree between non-target anchor nodes (i.e., anchor nodes other than the target anchor nodes in the plurality of anchor nodes) and the target terminal.

The plurality of anchor nodes may be sorted in a descending order according to the correlation degree with the target terminal, and the first N anchor nodes in the order of the correlation degree with the target terminal may be selected as the N target anchor nodes.

Alternatively, in another embodiment, one anchor node whose correlation degree with the target terminal is greater than the correlation degree threshold may be selected as the target anchor node. Optionally, when there is no anchor node whose correlation degree with the target terminal is greater than the correlation degree threshold, the first N anchor nodes in the order of the correlation degree with the target terminal may be selected as N target anchor nodes.

Optionally, the correlation between one anchor node and the target terminal may be characterized by the signal strength between the anchor node and the target terminal. When the signal strength between the anchor node and the target terminal is stronger, the correlation between the anchor node and the target terminal may be greater. And, when the signal strength between the anchor node and the target terminal is weaker, the correlation between the anchor node and the target terminal may be smaller.

Correspondingly, the signal strength between one target anchor node and the target terminal may be greater than the signal strength between the non-target anchor node and the target terminal.

In one embodiment, when the program is executed by the at least one processor 13, the at least one processor 13 may be configured to execute:
receiving the configuration information of each anchor node sent by the first terminal, where the configuration information of the i-th anchor node (any one of the plurality of anchor nodes) may include but is not limited to identification information (for example, ID) of the i-th anchor node, access signal format of the i-th anchor node, etc.;
sending a link establishment request to each anchor node based on the configuration information of the anchor node; and
receiving a link establishment success signal fed back by one anchor node. When the link establishment success signal fed back by the i-th anchor node is received, it may be indicated that the i-th anchor node is determined as one target anchor node. When the link establishment success signal fed back by the i-th anchor node is not received, it may be indicated that the i-th anchor node is not determined as the target anchor node.

After the target terminal receives the configuration information of the i-th anchor node, it may send the link establishment request to the i-th anchor node based on the configuration information of the i-th anchor node. After the i-th anchor node receives the link establishment request sent by the target terminal, it may measure the strength of the access signal carrying the link establishment request, obtain the signal strength between the target terminal and the i-th anchor node, and send the signal strength to the first terminal, such that the first terminal is able to determine whether the i-th anchor node is a target anchor node. When the first terminal determines that the i-th anchor node is a target anchor node, it may send the link establishment confirmation information to the i-th anchor node, and the i-th anchor node may feed back the link establishment success signal to the target terminal to establish the link with the target terminal.

That is, in the present embodiment, the at least one target anchor node may be determined in the process of establishing the links between the target terminal and the anchor nodes.

In another optional embodiment, the at least one target anchor node may be determined after the target terminal and the anchor nodes establish links. Based on this, when the program is executed by the at least one processor 13, the at least one processor 13 may be configured to execute:
receiving the configuration information of each anchor node sent by the first terminal, where the configuration information of the i-th anchor node (any one of the plurality of anchor nodes) may include but is not limited to identification information (e.g., ID) of the i-th anchor node, access signal format of the i-th anchor node, etc.;
establishing a link with the anchor node based on the configuration information of the anchor node, where the target terminal may send the link establishment request to the i-th anchor node according to the configuration information of the i-th anchor node, receive the link establishment success signal fed back by the i-th anchor node, and establish the link with the i-th anchor node, and the i-th anchor node may also send the link establishment success signal to the first terminal; and
receiving reference signal configuration information for link quality measurement sent by the first terminal. Optionally, the reference signal configuration information may be sent by the first terminal to the i-th anchor node after receiving the link establishment success signal sent by the i-th anchor node.

The reference signal configuration information may be used to determine the signal strength between the target terminal and each anchor node. The signal strength between the target terminal and each anchor node may be used to determine the at least one target anchor node.

Optionally, when the program is executed by the at least one processor 13, the at least one processor 13 may be configured to execute:
based on the reference signal configuration information, receiving the reference signal for link quality measurement sent by each anchor node, where the target terminal may receive the reference signal for link quality measurement sent by the i-th anchor node based on the reference signal configuration information for the i-th anchor node;
calculating the signal strength between the target terminal and each anchor node based on the reference signal sent by the anchor node, where the target terminal may calculate the signal strength between the target terminal and the i-th anchor node based on the reference signal sent by the i-th anchor node; and
feeding back the signal strength between the target terminal and each anchor node to the first terminal, where the target terminal may feed back the signal strength between the target terminal and each anchor node to the first terminal after calculating the signal strength between the target terminal and each anchor node.

Optionally, when the program stored in the memory 33 is executed by the at least one processor 13, the at least one processor 13 may be configured to execute:
based on the reference signal configuration information, sending the reference signal for link quality measurement to each anchor node, where the target terminal may send the reference signal for link quality measurement to each anchor node based on the reference signal configuration information.

The reference signal may be used to calculate the signal strength between the target terminal and the anchor node. The i-th anchor node may calculate the signal strength between the target terminal and the i-th anchor node based on the reference signal sent by the target terminal. The signal strength between the target terminal and each anchor node may be used to determine the at least one target anchor node. After the i-th anchor node determines the signal strength between the target terminal and the i-th anchor node, it may send the signal strength between the target terminal and the i-th anchor node to the first terminal, such that the first terminal determines the at least one target anchor node according to the signal strength between the target terminal and each anchor node.

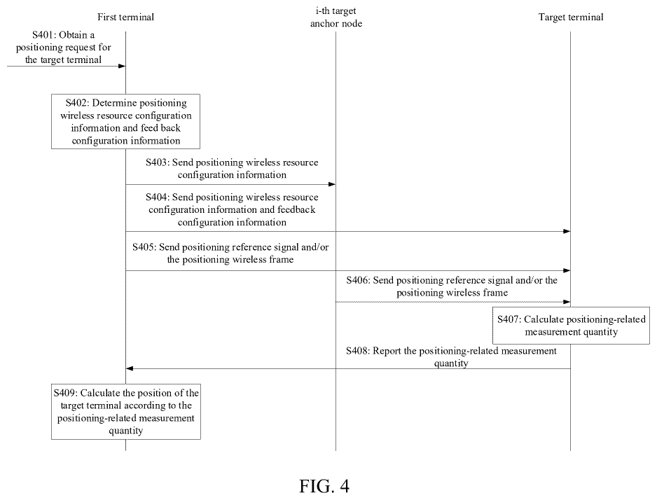

The present disclosure also provides another positioning method. As shown in FIG. 4, which is a flow chart of another positioning method provided by the embodiments of the present disclosure, in another embodiment, the method includes S401 to S409.:
S401: The first terminal obtains a positioning request for the target terminal.
S402: The first terminal determines the positioning wireless resource configuration information and feedback configuration information.
S403: The first terminal sends the above positioning wireless resource configuration information to at least one target anchor node. The interaction mode of each target anchor node with the first terminal and the target terminal may be the same. FIG. 4 only shows the interaction mode of the j-th target anchor node with the first terminal and the target terminal.
S404: The first terminal sends the above positioning wireless resource configuration information and feedback configuration information to the target terminal.

The execution order of S403 and S404 is not limited in the present disclosure.
S403 may be executed first, and then S404. Or, S404 may be executed first, and then S403. Or, S403 and S404 may be executed simultaneously.
S405: The first terminal sends the positioning reference signal and/or the positioning wireless frame to the target terminal.
S406: Each target anchor node sends the positioning reference signal and/or the positioning wireless frame to the target terminal.

The execution order of S405 and S406 is not limited in the present disclosure. S405 may be executed first, and then S406. Or, S405 may be executed first, and then S406. Or, S405 and S406 may be executed simultaneously.
S407: The target terminal calculates the positioning-related measurement quantity corresponding to the first terminal according to the positioning reference signal and/or positioning wireless frame sent by the first terminal, and calculates the positioning-related measurement quantity corresponding to each target anchor node according to the positioning reference signal and/or positioning wireless frame sent by each target anchor node.
S408: The target terminal reports the positioning-related measurement quantity corresponding to the first terminal and the positioning-related measurement quantity corresponding to each target anchor node to the first terminal.
S409: The first terminal calculates the position of the target terminal according to the positioning-related measurement quantity corresponding to the first terminal and the positioning-related measurement quantity corresponding to each target anchor node.

If the positioning request for the target terminal is sent by other devices to the first terminal, the first terminal may also report the position of the target terminal to other devices. If the positioning request for the target terminal is generated by the first terminal, the first terminal may not report the position of the target terminal to other devices, and of course, it may also report the position of the target terminal to other devices.

The specific implementation process of each of S401-S409 may refer to the aforementioned embodiments, which will not be repeated here.

FIG. 4 is an example of the target terminal reporting the positioning-related measurement quantity corresponding to the first terminal and the positioning-related measurement quantity corresponding to each target anchor node to the first terminal. As described in the aforementioned embodiments, the target terminal may also calculate the position of the target terminal based on the positioning-related measurement quantity corresponding to the first terminal and the positioning-related measurement quantity corresponding to each target anchor node, and report the position of the target terminal to the first terminal.

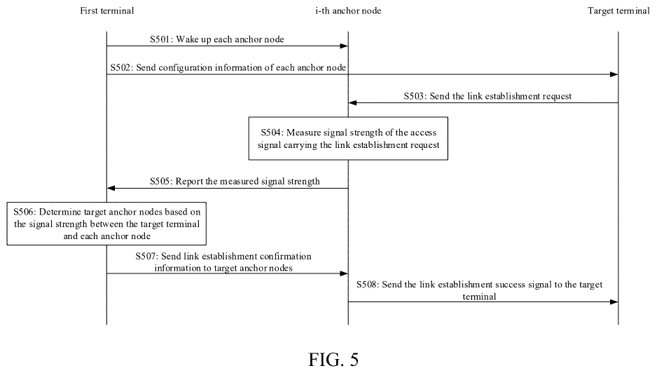

As shown in FIG. 5 which is a flow chart of selecting at least one target anchor node from a plurality of anchor nodes, in one embodiment, selecting at least one target anchor node from a plurality of anchor nodes may include S501 to S508.
S501: The first terminal wakes up each anchor node, that is, enables each anchor node.
S502: The first terminal sends configuration information of each anchor node to the target terminal.
S503: The target terminal sends the link establishment request to each anchor node according to the configuration information of each anchor node. Each anchor node may interact with the first terminal and the target terminal in the same manner, and only the i-th anchor node is shown in FIG. 5.
S504: Each anchor node measures the signal strength of the access signal carrying the link establishment request. That is, the i-th anchor node may measure the signal strength of the access signal carrying the link establishment request sent by the target terminal to the i-th anchor node, and obtain the signal strength between the i-th anchor node and the target terminal.
S505: Each anchor node reports the measured signal strength to the first terminal. That is, the i-th anchor node may report the signal strength between the i-th anchor node and the target terminal to the first terminal.
S506: The first terminal determines the at least one target anchor node based on the signal strength between the target terminal and each anchor node.
S507: The first terminal sends link establishment confirmation information to the at least one target anchor node. FIG. 5 uses the i-th anchor node being determined as the target anchor node as an example for illustration. When the i-th anchor node is not determined as the target anchor node, the first terminal may not send link establishment confirmation information to the i-th anchor node.
S508: The at least one target anchor node sends the link establishment success signal to the target terminal. That is, only anchor nodes determined as target anchor nodes may establish the links with the target terminal.

The specific implementation process of S501-S508 may refer to the aforementioned embodiments, which will not be repeated here.

After determining the at least one target anchor node, the subsequent process of positioning the target terminal based on the at least one target anchor node may be executed.

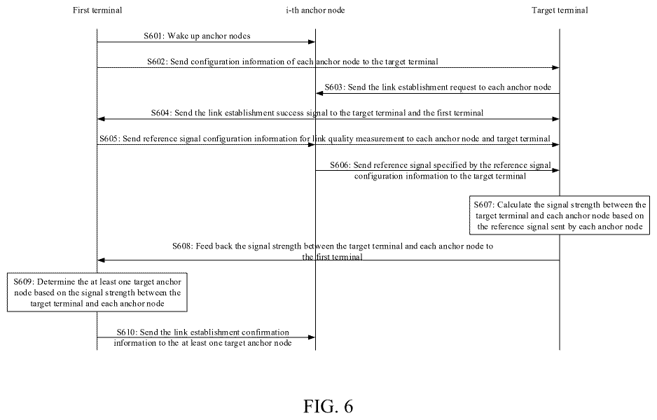

In another embodiment shown in FIG. 6, selecting at least one target anchor node from a plurality of anchor nodes may include:
S601: The first terminal wakes up each anchor node, that is, enables each anchor node.
S602: The first terminal sends the configuration information of each anchor node to the target terminal.
S603: The target terminal sends the link establishment request to each anchor node according to the configuration information of each anchor node. Each anchor node may interact with the first terminal and the target terminal in the same way, and only the i-th anchor node is shown in FIG. 6.
S604: Each anchor node sends the link establishment success signal to the target terminal and the first terminal respectively.
S605: The first terminal sends the reference signal configuration information for link quality measurement to each anchor node and the target terminal respectively.
S606: Each anchor node sends the reference signal specified by the reference signal configuration information to the target terminal respectively.
S607: The target terminal calculates the signal strength between the target terminal and each anchor node based on the reference signal sent by each anchor node. For example, the target terminal may calculate the signal strength between the target terminal and the i-th anchor node based on the reference signal sent by the i-th anchor node.
S608: The target terminal feeds back the signal strength between the target terminal and each anchor node to the first terminal.
S609: The first terminal determines the at least one target anchor node based on the signal strength between the target terminal and each anchor node.
S610: The first terminal sends the link establishment confirmation information to the at least one target anchor node. FIG. 6 uses the i-th anchor node being determined as the target anchor node as an example for explanation. When the i-th anchor node is not determined as the target anchor node, the first terminal may not send link establishment confirmation information to the i-th anchor node. One anchor node that receives the link establishment confirmation information may determine that it is determined as the target anchor node, which may be used for subsequent auxiliary positioning.

For the specific implementation process of S601-S610, reference may be made to the aforementioned embodiments, which will not be repeated here.

The embodiment shown in FIG. 6 where one anchor node sends a reference signal specified by reference signal configuration information to the target terminal and the target terminal feeds back the signal strength between the target terminal and each anchor node to the first terminal, is used as an example to illustrate the process of determining the at least one target anchor node in the present disclosure. In other embodiments, the target terminal may also send the reference signal specified by the reference signal configuration information to each anchor node, and each anchor node may calculate the signal strength between the target terminal and the anchor node based on the reference signal sent by the target terminal. And then each anchor node may feed back the signal strength between the anchor node and the target terminal to the first terminal.

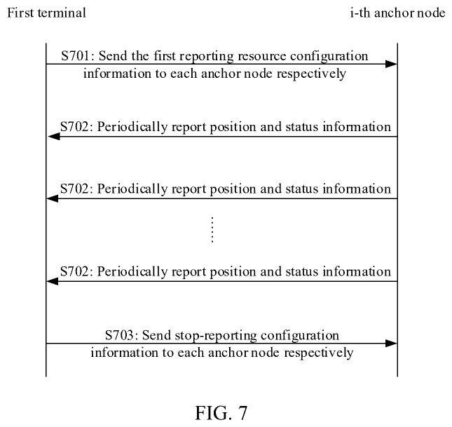

In one embodiment shown in FIG. 7, monitoring each anchor node by the first terminal may include:
S701: The first terminal sends the first reporting resource configuration information to each anchor node respectively.
S702: Each anchor node periodically reports the position and status information. For example, each anchor node may report the position and status information of the anchor node to the first terminal according to the target period based on the first target frequency specified by the first reporting resource configuration information. For example, the i-th anchor node may report the position and status information of the i-th anchor node to the first terminal according to the target period based on the first target frequency specified by the first reporting resource configuration information. Each anchor node may interact with the first terminal in the same manner, and only the i-th anchor node is shown in FIG. 7.
S703: The first terminal sends the stop-reporting configuration information to each anchor node respectively, such that each anchor node stops reporting the position and status information to the first terminal. The first terminal may send the stop-reporting configuration information to the i-th anchor node, such that the i-th anchor node stops reporting the position and status information of the i-th anchor node to the first terminal.

The first terminal may send the first reporting resource configuration information to the i-th anchor node once, and the i-th anchor node may periodically report the position and status information of the i-th anchor node to the first terminal multiple times.

The specific implementation process of S701-S703 can refer to the aforementioned embodiments, which will not be repeated here.

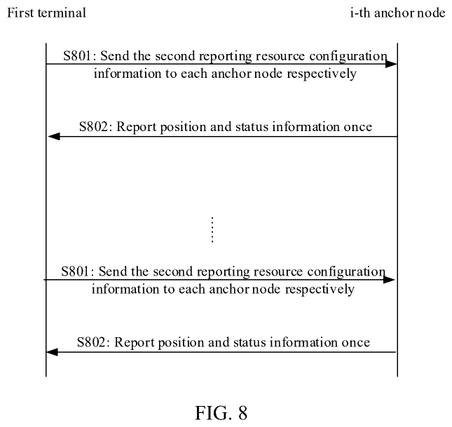

In another embodiment shown in FIG. 8, monitoring each anchor node by the first terminal may include S801 to S802:
S801: The first terminal sends the second reporting resource configuration information to each anchor node respectively.
S802: Each anchor node reports the position and status information once. Each anchor node may report the position and status information of the anchor node to the first terminal once based on the second target frequency specified by the second reporting resource configuration information. For example, the i-th anchor node reports the position and status information of the i-th anchor node to the first terminal once based on the second target frequency specified by the second reporting resource configuration information. Each anchor node may interact with the first terminal in the same way, and only the i-th anchor node is shown in FIG. 8.

That is, the first terminal may send the second reporting resource configuration information to the i-th anchor node once, and the i-th anchor node may report the position and state information of the i-th anchor node to the first terminal only once.

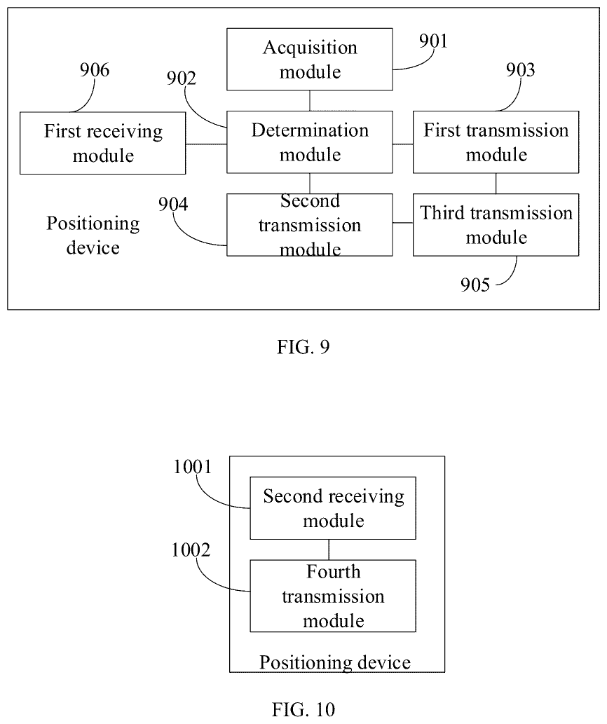

Corresponding to the method embodiment shown in FIG. 1B, the present disclosure further provides a positioning device. As shown in FIG. 9, which is a structural schematic diagram of the positioning device, the positioning device may include:
an acquisition module 901 configured to obtain a positioning request for a target terminal;
a determination module 902 configured to determine positioning wireless resource configuration information and feedback configuration information in response to the positioning request;
a first transmission module 903 configured to send the positioning wireless resource configuration information to at least one target anchor node;
a second transmission module 904 configured to send the above positioning wireless resource configuration information and feedback configuration information to the target terminal;
a third transmission module 905 configured to send a positioning parameter signal and/or a positioning wireless frame to the target terminal; and
a first receiving module 906 configured to receive target information reported by the target terminal based on the feedback configuration information.

The target information may include: the positioning-related measurement quantity corresponding to the first terminal and the positioning-related measurement quantity corresponding to each target anchor node. Or, the target information may include the position of the target terminal.

The positioning-related measurement quantity corresponding to the first terminal and the positioning-related measurement quantity corresponding to each target anchor node are used to determine the position of the target terminal.

The positioning-related measurement quantity corresponding to the first terminal may be obtained by calculation based on the target terminal according to the positioning parameter signal and/or positioning wireless frame sent by the first terminal.

Corresponding to the method embodiment shown in FIG. 2B, another embodiment of the present disclosure also provides another positioning device, which is used for a second terminal, where the second terminal may be a target anchor node selected from a plurality of anchor nodes. The plurality of anchor nodes may include terminals that have registered with the first terminal. The correlation degree between one target anchor node and the target terminal may be higher than the correlation degree between non-target anchor node in the plurality of anchor nodes and the target terminal. The target terminal may be a terminal to be positioned.

In the present embodiment, as shown in FIG. 10, the positioning device may include:
a second receiving module 1001 configured to receive positioning wireless resource configuration information sent by the first terminal; and
a fourth transmission module 1002 configured to send a positioning reference signal and/or a positioning wireless frame to the target terminal according to the positioning wireless resource configuration information.

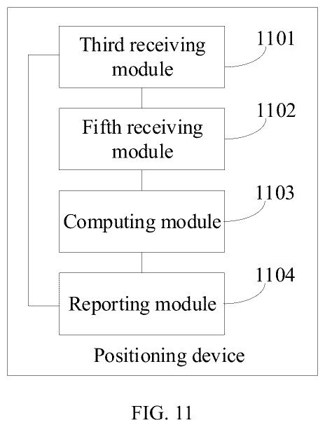

Corresponding to the method embodiment shown in FIG. 3B, another embodiment of the present disclosure also provides another positioning device. As shown in FIG. 11, the positioning device may include:
a third receiving module 1101 configured to receive positioning wireless resource configuration information and feedback configuration information sent by the first terminal;
a fifth receiving module 1102 configured to receive the positioning reference signal and/or positioning wireless frame sent by the first terminal and the positioning reference signal and/or positioning wireless frame sent by at least one target anchor node based on the wireless resource configuration information;
a calculation module 1103 configured to calculate the positioning-related measurement quantity corresponding to the first terminal according to the positioning reference signal and/or positioning wireless frame sent by the first terminal, and calculate the positioning-related measurement quantity corresponding to the target anchor node according to the positioning reference signal and/or positioning wireless frame sent by the target anchor node; and
a reporting module 1104 configured to report the target information to the first terminal based on the feedback configuration information. The target terminal may report the target information to the first terminal based on the feedback transmission format specified by the feedback configuration information.

The target information may include: the positioning-related measurement quantity corresponding to the first terminal and the positioning-related measurement quantity corresponding to each target anchor node. Or, the target information may include the position of the target terminal.

The positioning-related measurement quantity corresponding to the first terminal and the positioning-related measurement quantity corresponding to each target anchor node may be used to determine the position of the target terminal.

The positioning-related measurement quantity corresponding to the first terminal and the positioning-related measurement quantity corresponding to each target anchor node may be used to determine the position of the target terminal.

Corresponding to the method embodiment, one embodiment of the present disclosure also provides a storage medium, which is configured to store a program suitable for execution by a processor. The program is used to:
obtain a positioning request for a target terminal;
determine positioning wireless resource configuration information and feedback configuration information in response to the positioning request;
send the positioning wireless resource configuration information to at least one target anchor node;
send the positioning wireless resource configuration information and the feedback configuration information to the target terminal;
send a positioning parameter signal and/or a positioning wireless frame to the target terminal; and
receive the target information reported by the target terminal based on the feedback configuration information.

The target information may include: the positioning-related measurement quantity corresponding to the first terminal and the positioning-related measurement quantity corresponding to each target anchor node. Or, the target information may include the position of the target terminal.

The positioning-related measurement quantity corresponding to the first terminal and the positioning-related measurement quantity corresponding to each target anchor node may be used to determine the position of the target terminal.

In another embodiment, when the processor executes the program stored in the storage medium, the processor may be further configured to:
receive the positioning wireless resource configuration information sent by the first terminal; and
send a positioning reference signal and/or a positioning wireless frame to the target terminal according to the positioning wireless resource configuration information.

Alternatively, when the processor executes the program stored in the storage medium, the processor may be further configured to:
receive the positioning wireless resource configuration information and the feedback configuration information sent by the first terminal;
receive the positioning reference signal and/or the positioning wireless frame sent by the first terminal, and the positioning reference signal and/or the positioning wireless frame sent by at least one target anchor node based on the wireless resource configuration information;
calculate the positioning-related measurement quantity corresponding to the first terminal according to the positioning reference signal and/or positioning wireless frame sent by the first terminal, and calculate the positioning-related measurement quantity corresponding to the target anchor node according to the positioning reference signal and/or positioning wireless frame sent by the target anchor node; and
report target information to the first terminal based on the feedback configuration information.

The target information may include: the positioning-related measurement quantity corresponding to the first terminal and the positioning-related measurement quantity corresponding to each target anchor node. Or, the target information may include the position of the target terminal.

The positioning-related measurement quantity corresponding to the first terminal and the positioning-related measurement quantity corresponding to each target anchor node may be used to determine the position of the target terminal.

Optionally, the detailed functions and extended functions of the program can refer to the above description.

Those skilled in the art may realize that the units and algorithm steps of each example described in the embodiments disclosed herein may be implemented in electronic hardware or in a combination of computer software and electronic hardware. Whether these functions are performed in hardware or software depends on the specific application and design constraints of the technical solution. Professional technicians may use different methods to implement the described functions for each specific application, but such implementation should not be considered to be beyond the scope of the present disclosure.

In the embodiments of the present disclosure, it should be understood that the disclosed systems, devices and methods may be implemented in other ways. Mutual coupling or direct coupling or communication connection shown or discussed may be through some interfaces, indirect coupling or communication connection of devices or units, which can be electrical, mechanical or other forms.

The units described as separate components may or may not be physically separated, and the components displayed as units may or may not be physical units. That is, they may be located in one place, or they may be distributed on multiple network units. Some or all of the units can be selected according to actual needs to achieve the purpose of the scheme of the present disclosure.

Further, each functional unit in each embodiment of the present disclosure may be integrated into a processing unit, or each unit may exist physically separately, or two or more units may be integrated into one unit.

It should be understood that in the embodiments of the present disclosure, the dependent claims, various embodiments, and features may be combined with each other to achieve the solution of the aforementioned technical problems.

If one function is implemented in the form of a software functional unit and sold or used as an independent product, it may be stored in a computer-readable storage medium. Based on this understanding, a part of the technical solution of the present disclosure that is essentially or a part that contributes to the prior art or the technical solution may be embodied in the form of a software product, which is stored in a storage medium and includes several instructions for a computer device (which can be a personal computer, a server, or a network device, etc.) to perform all or part of the steps of the methods described in each embodiment of the present disclosure. The aforementioned storage medium may include: a flash disk, a mobile hard disk, read-only memory (ROM), random access memory (RAM), a magnetic disk or an optical disk, or other media that can store program code.

The above are only some embodiments of the present disclosure, which are used as examples to illustrate the present disclosure and make those skilled in the art implement or use the present disclosure It should be noted that for those of ordinary skill in the art, improvements and modifications can be made without departing from the principles of the present disclosure, and may be obvious. The general principles defined herein may be embodied in other embodiments without departing from the spirit or scope of the present disclosure. Accordingly, the present disclosure is not intended to be limited to the embodiments shown herein, but is to be accorded the widest scope consistent with the principles and novel features disclosed herein.

1.-13. (canceled)

14. A terminal comprising:
a memory storing a program; and
a processor configured to execute the program to:
obtain a positioning request for a target terminal;
determine positioning wireless resource configuration information and feedback configuration information in response to the positioning request;
send the positioning wireless resource configuration information to at least one target anchor node;
send the positioning wireless resource configuration information and the feedback configuration information to the target terminal;
send at least one of a positioning parameter signal or a positioning wireless frame to the target terminal; and
receive target information reported by the target terminal based on the feedback configuration information, the target information including:
a position of the target terminal, or
a positioning-related measurement quantity corresponding to the terminal and a positioning-related measurement quantity corresponding to each target anchor node that are used to determine the position of the target terminal.

15. The terminal according to claim 14, wherein:
the at least one target anchor node is selected from a plurality of anchor nodes that have registered with the terminal; and
a correlation degree between each of the at least one target anchor node and the target terminal is higher than a correlation degree between a non-target anchor node among the plurality of anchor nodes and the target terminal.

16. The terminal according to claim 15, wherein the correlation degree includes a signal strength.

17. The terminal according to claim 16, wherein the processor is further configured to execute the program to:
send configuration information of each anchor node to the target terminal;
receive the signal strength between the target terminal and each anchor node sent by the anchor node; and
determine the at least one target anchor node based on the signal strength between the target terminal and each anchor node.

18. The terminal according to claim 16, wherein the processor is further configured to execute the program to:
send configuration information of each anchor node to the target terminal;
receive a link establishment success signal sent by each anchor node that indicates that the anchor node has established a link with the target terminal;
send reference signal configuration information for link quality measurement to the target terminal and each anchor node;
receive the signal strength between the target terminal and each anchor node; and
determine the at least one target anchor node based on the signal strength between the target terminal and each anchor node.

19. The terminal according to claim 15, wherein the processor is further configured to execute the program to:
send first reporting resource configuration information to each anchor node and receive position and status information reported by each anchor node according to a target period based on a first target frequency; or
send second reporting resource configuration information to each anchor node and receive the position and status information reported by each anchor node based on a second target frequency.

20. The terminal according to claim 15, wherein:
each of the plurality of anchor nodes is either a static anchor node or a dynamic anchor node, the dynamic anchor node being a mobile terminal; and
the processor is further configured to execute the program to:
in response to the at least one target anchor node including one or more dynamic anchor nodes, send an auxiliary positioning request to each of the one or more dynamic anchor nodes; and
in response to receiving first information fed back by the one or more dynamic anchor nodes, perform sending the positioning wireless resource configuration information to the at least one target anchor node.

21. The terminal according to claim 14, wherein the processor is further configured to execute the program to:
broadcast anchor node query information; and
receive an anchor node registration request sent by a device, and record relevant information of the device carried in the anchor node registration request;
wherein:
the relevant information at least includes an identification identifier and position information of the device; and
the anchor node registration request is sent by the device to the terminal after receiving the anchor node query information.

22. A positioning method applied to the terminal according to claim 14, comprising:
obtaining the positioning request for the target terminal;
determining the positioning wireless resource configuration information and the feedback configuration information in response to the positioning request;
sending the positioning wireless resource configuration information to the at least one target anchor node;
sending the positioning wireless resource configuration information and the feedback configuration information to the target terminal;
sending the at least one of the positioning parameter signal or the positioning wireless frame to the target terminal; and
receiving the target information reported by the target terminal based on the feedback configuration information.

23. The method according to claim 22, wherein:
the at least one target anchor node is selected from a plurality of anchor nodes that have registered with the terminal; and
a correlation degree between each of the at least one target anchor node and the target terminal is higher than a correlation degree between a non-target anchor node among the plurality of anchor nodes and the target terminal.

24. The method according to claim 23, wherein the correlation degree includes a signal strength.

25. The method according to claim 24, further comprising:
sending configuration information of each anchor node to the target terminal;
receiving the signal strength between the target terminal and each anchor node sent by the anchor node; and
determining the at least one target anchor node based on the signal strength between the target terminal and each anchor node.

26. The method according to claim 24, further comprising:
sending configuration information of each anchor node to the target terminal;
receiving a link establishment success signal sent by each anchor node that indicates that the anchor node has established a link with the target terminal;
sending reference signal configuration information for link quality measurement to the target terminal and each anchor node;
receiving the signal strength between the target terminal and each anchor node; and
determining the at least one target anchor node based on the signal strength between the target terminal and each anchor node.

27. The method according to claim 23, further comprising:
sending first reporting resource configuration information to each anchor node and receive position and status information reported by each anchor node according to a target period based on a first target frequency; or
sending second reporting resource configuration information to each anchor node and receive the position and status information reported by each anchor node based on a second target frequency.

28. The method according to claim 23,
wherein each of the plurality of anchor nodes is either a static anchor node or a dynamic anchor node, the dynamic anchor node being a mobile terminal;
the method further comprising:
in response to the at least one target anchor node including one or more dynamic anchor nodes, sending an auxiliary positioning request to each of the one or more dynamic anchor nodes; and
in response to receiving first information fed back by the one or more dynamic anchor nodes, performing sending the positioning wireless resource configuration information to the at least one target anchor node.

29. The method according to claim 22, further comprising:
broadcasting anchor node query information; and
receiving an anchor node registration request sent by a device, and record relevant information of the device carried in the anchor node registration request;
wherein:
the relevant information at least includes an identification identifier and position information of the device; and
the anchor node registration request is sent by the device to the terminal after receiving the anchor node query information.

30. A second terminal comprising:
a memory storing a program; and
a processor configured to execute the program to:
receive positioning wireless resource configuration information sent by a first terminal, the second terminal being a target anchor node selected from a plurality of anchor nodes that have registered with a first terminal, a correlation degree between the target anchor node and the target terminal being higher than a correlation degree between a non-target anchor node among the plurality of anchor nodes and the target terminal; and
send at least one of a positioning reference signal or a positioning wireless frame to the target terminal according to the positioning wireless resource configuration information.

31. A positioning method applied to the second terminal according to claim 30, comprising:
receiving the positioning wireless resource configuration information sent by the first terminal; and
sending the at least one of the positioning reference signal or the positioning wireless frame to the target terminal according to the positioning wireless resource configuration information.

32. A target terminal comprising:
a memory storing a program; and
a processor configured to execute the program to:
receive positioning wireless resource configuration information and feedback configuration information sent by a first terminal;
receive, based on the wireless resource configuration information, at least one of a positioning reference signal or a positioning wireless frame sent by the first terminal and at least one of a positioning reference signal or a positioning wireless frame sent by at least one target anchor node;
calculate a positioning-related measurement quantity corresponding to the first terminal according to the at least one of the positioning reference signal or the positioning wireless frame sent by the first terminal, and calculate a positioning-related measurement quantity corresponding to the at least one target anchor node according to the at least one of the positioning reference signal or the positioning wireless frame sent by the at least one target anchor node; and
report target information to the first terminal based on the feedback configuration information, the target information including:
a position of the target terminal, or
a positioning-related measurement quantity corresponding to the first terminal and a positioning-related measurement quantity corresponding to the at least one target anchor node that are used to determine the position of the target terminal.

33. A positioning method applied to the target terminal according to claim 32, comprising:
receiving the positioning wireless resource configuration information and the feedback configuration information sent by the first terminal;
receiving, based on the wireless resource configuration information, the at least one of the positioning reference signal or the positioning wireless frame sent by the first terminal and the at least one of the positioning reference signal or the positioning wireless frame sent by at least one target anchor node;
calculating the positioning-related measurement quantity corresponding to the first terminal according to the at least one of the positioning reference signal or the positioning wireless frame sent by the first terminal, and calculating the positioning-related measurement quantity corresponding to the at least one target anchor node according to the at least one of the positioning reference signal or the positioning wireless frame sent by the at least one target anchor node;
reporting the target information to the first terminal based on the feedback configuration information.
